(19) United States
(12) Patent Application Publication
(10) Pub. No.: US 2013/0313448 A1
(43) Pub. Date: Nov. 28, 2013

(54) LIGHT SPLITTING AND DETECTING SYSTEM

(71) Applicants: SINTAI OPTICAL (SHENZHEN) CO., LTD., Guandong Province (CN); ASIA OPTICAL INTERNATIONAL LTD., Tortola (GB)

(72) Inventors: Chia-Tse Sun, Taichung City (TW); Kuo-Shun Huang, Taichung City (TW); Chia-Jen Lee, Taichung City (TW)

(73) Assignees: ASIA OPTICAL INTERNATIONAL LTD., Tortola (GB); SINTAI OPTICAL (SHENZHEN) CO., LTD., Guandong Province (CN)

(21) Appl. No.: 13/781,724

(22) Filed: Feb. 28, 2013

(30) Foreign Application Priority Data
May 23, 2012 (TW) 101118343

(51) Int. Cl. G02B 6/35; G02B 27/14

(52) U.S. Cl. CPC G02B 6/3586; G02B 27/141
USPC 250/578.1; 359/634; 359/350; 385/16

(57) ABSTRACT

A light splitting and detecting system including at least one light splitting and detecting apparatus is provided. The light splitting and detecting apparatus is capable of receiving a first wavelength optical signal and a second wavelength optical signal. The light splitting and detecting apparatus includes a filter, light detecting unit, a first wavelength filtering unit and a slit. The filter is disposed on the transmission path of the first wavelength optical signal and the second wavelength optical signal. The first wavelength filtering unit is disposed between the filter and the light detecting unit. The slit is disposed between the first wavelength filtering unit and the light detecting unit and expose the light detecting unit.

### CROSS-REFERENCE TO RELATED APPLICATION

This application claims the priority benefit of Taiwan application serial no. 101118343, filed on May 23, 2012. The entirety of the above-mentioned patent application is hereby incorporated by reference herein and made a part of this specification.

### BACKGROUND

1. Technical Field

The invention relates to a light splitting and detecting system. Particularly, the invention relates to a light splitting and detecting system having a slit.

2. Related Art

Along with increase of network users, data transmission amount is also increased. In the conventional technique, electric signals are used for communication. However, since the electric signals have a limitation in bandwidth, a network congestion phenomenon is inevitable. Therefore, many network service providers provide network services to the users through an optical fiber communication technique. A bandwidth of the optical fiber communication technique is greater than a bandwidth of the communication technique using the electric signals. Therefore, by using the optical fiber communication technique, the network service provider can provide better network services to the user.

At least two optical fibers are configured in a conventional optical fiber line, where one optical fiber serves as a main channel (which is also referred to as a main core), and the other optical fiber serves as an alternate channel (which is also referred to as an alternate core). The main channel is set as an initial light transmission path, and when the main channel is failed, the light transmission path can be switched to the alternate channel, so that a light signal can still be normally transmitted in the optical fiber line.

In order to achieve a concept of non-interruption in signal transmission, an optical protection system (OPS) plays an important role. When the main channel of the optical fiber line is failed, the OPS can switch the light transmission path to the alternate channel. The current OPS techniques are generally researched and developed by the manufactures, the entire system has a large size, and a switching speed thereof is not fast.

### SUMMARY

The invention is directed to a light splitting and detecting system, which has a better detection effect.

An embodiment of the invention provides a light splitting and detecting system including at least one light splitting and detecting apparatus. The light splitting and detecting apparatus is capable of receiving a first wavelength optical signal and a second wavelength optical signal. The light splitting and detecting apparatus includes a filter, a light detecting unit, a first wavelength filtering unit and a slit. The filter is disposed on a transmission path of the first wavelength optical signal and the second wavelength optical signal. The first wavelength optical signal is divided into a first working optical signal and a first monitoring optical signal, and the second wavelength optical signal is divided into a second working optical signal and a second monitoring optical signal. The filter reflects the first working optical signal and the second working optical signal, and is pervious to the first monitoring optical signal and the second monitoring optical signal. The light detecting unit is disposed on a transmission path of the first monitoring optical signal passing through the filter. The first wavelength filtering unit is disposed between the filter and the light detecting unit. The first wavelength filtering unit is pervious to the first monitoring optical signal and reflects at least a part of the second monitoring optical signal. The slit is disposed between the first wavelength filtering unit and the light detecting unit and exposes the light detecting unit.

In an embodiment of the invention, the light splitting and detecting system further includes an optical path switching device, which is disposed on a transmission path of the first working optical signal and the second working optical signal divided by each of the light splitting and detecting apparatuses. The optical path switching device is adapted to make the first working optical signal and the second working optical signal divided by one of the light splitting and detecting apparatuses to pass through the optical path switching device according to a value of a first monitoring electric signal sent by the optical detecting unit of each of the light splitting and detecting apparatuses.

In an embodiment of the invention, the at least one light splitting and detecting apparatus includes at least two light splitting and detecting apparatuses.

In an embodiment of the invention, the light splitting and detecting system further includes a micro control unit. The micro control unit is coupled to the light detecting unit of each of the light splitting and detecting apparatuses, analyses the first monitoring electric signal, and controls the optical path switching device according to the value of the first monitoring electric signal to make the first working optical signal and the second working optical signal divided by one of the light splitting and detecting apparatuses to pass through the optical path switching device.

In an embodiment of the invention, the light splitting and detecting system further includes a plurality of amplifying elements. The amplifying elements are respectively disposed between the light splitting and detecting apparatus and the micro control unit, and amplify the first monitoring electric signals and output the amplified first monitoring electric signals to the micro control unit.

In an embodiment of the invention, the light splitting and detecting system further includes a control circuit. The control circuit is coupled between the micro control unit and the optical path switching device, and the control circuit is controlled by the micro control unit to drive the optical path switching device to make the first working optical signal and the second working optical signal divided by one of the light splitting and detecting apparatuses to pass through the optical path switching device.

In an embodiment of the invention, the light splitting and detecting system further includes a first light guide unit and a second light guide unit, and the filter is disposed between the first light guide unit, the second light guide unit and the first wavelength filtering unit. The first wavelength optical signal is transmitted to the filter through the first light guide unit, and the second wavelength optical signal is transmitted to the filter through the second light guide unit, where a tangential direction of the first light guide unit near the filter is intersected with a tangential direction of the second light guide unit near the filter.

In an embodiment of the invention, the slit is a conical slit.

In an embodiment of the invention, the conical slit has a first opening and a second opening opposite to each other, the first opening is located between the second opening and the first wavelength filtering unit, and the second opening covers at least a part of the light detecting unit.

In an embodiment of the invention, a diameter of the first opening is smaller than a diameter of the second opening.

In an embodiment of the invention, the light splitting and detecting system further includes a second wavelength filtering unit disposed between the first wavelength filtering unit and the slit, which is pervious to the first monitoring optical signal and reflects at least a part of the second monitoring optical signal.

In an embodiment of the invention, a wavelength of the first wavelength optical signal is 1310 nanometer (nm), and a wavelength of the second wavelength optical signal is 1490 nm or 1550 nm.

In an embodiment of the invention, a light intensity of the first working optical signal is 95% of a light intensity of the first wavelength optical signal, a light intensity of the first monitoring optical signal is 5% of the light intensity of the first wavelength optical signal, a light intensity of the second working optical signal is 95% of a light intensity of the second wavelength optical signal, and a light intensity of the second monitoring optical signal is 5% of the light intensity of the second wavelength optical signal.

According to the above descriptions, the light splitting and detecting system of the invention uses the filter and the first wavelength filtering unit to filter the second wavelength optical signal, and uses the slit to block the interference on the light detecting unit caused by the second wavelength optical signal, so as to improve detecting accuracy of the light detecting unit.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a light splitting and detecting system according to an embodiment of the invention.

FIG. 2 is a schematic diagram of a light splitting and detecting system according to another embodiment of the invention.

### DETAILED DESCRIPTION OF DISCLOSED EMBODIMENTS

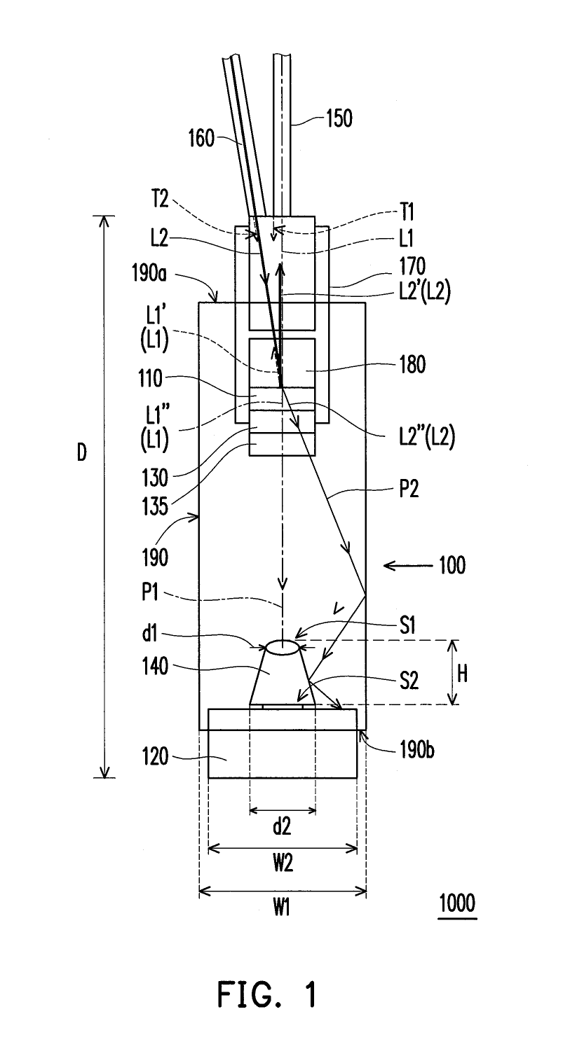

FIG. 1 is a schematic diagram of a light splitting and detecting system according to an embodiment of the invention. Referring to FIG. 1, the light splitting and detecting system 1000 includes at least one light splitting and detecting apparatus 100. The light splitting and detecting apparatus 100 includes a filter 110, a light detecting unit 120, a first wavelength filtering unit 130 and a slit 140. One light splitting and detecting apparatus 100 is illustrated in FIG. 1 for representation, and the number of the light splitting and detecting apparatuses can be adjusted according to an actual requirement. In the present embodiment, the light splitting and detecting apparatus 100 is adapted to receive a first wavelength optical signal L1 and a second wavelength optical signal L2, though the invention is not limited thereto, and in other embodiments, the number of the optical signals received by the light splitting and detecting apparatus 100 can be adjusted, for example, besides the first wavelength optical signal L1 and the second wavelength optical signal L2, the light splitting and detecting apparatus 100 can further receive a third wavelength optical signal. In the present embodiment, a wavelength of the first wavelength optical signal L1 is 1310 nanometer (nm), and a wavelength of the second wavelength optical signal L2 is 1490 nm or 1550 nm. Similarly, the invention is also not limited thereto, and in other embodiments, the wavelength of the optical signal can be other values.

The filter 110 is disposed on a transmission path of the first wavelength optical signal L1 and the second wavelength optical signal L2. The first wavelength optical signal L1 is divided into a first working optical signal L1′ and a first monitoring optical signal L1″. The second wavelength optical signal L2 is divided into a second working optical signal L2′ and a second monitoring optical signal L2″. The first working optical signal L1′ and the second working optical signal L2′ are used to transmit optical signals, and the first monitoring optical signal L1″ is adapted to be monitored by the light splitting and detecting apparatus 100. The filter 110 is used to reflect the first working optical signal L1′ and the second working optical signal L2′, and is pervious to the first monitoring optical signal L1″ and the second monitoring optical signal L2″.

Further, in the present embodiment, a light intensity of the first working optical signal L1′ can be 95% of a light intensity of the first wavelength optical signal L1, a light intensity of the first monitoring optical signal L1″ can be 5% of the light intensity of the first wavelength optical signal L1. Similarly, a light intensity of the second working optical signal L2′ can be 95% of a light intensity of the second wavelength optical signal L2, and a light intensity of the second monitoring optical signal L2″ can be 5% of the light intensity of the second wavelength optical signal L2. In other words, the filter 110 has a light splitting function. The filter 110 can reflect a part of the first wavelength optical signal L1 (the first working optical signal L1′) and a part of the second wavelength optical signal L2 (the second working optical signal L2′), and is pervious the other part of the first wavelength optical signal L1 (the first monitoring optical signal L1″) and the other part of the second wavelength optical signal L2 (the second monitoring optical signal L2″). However, the invention is not limited thereto, and in other embodiments, ratios of the first working optical signal L1′ and the first monitoring optical signal L1″ in the first wavelength optical signal L1 and ratios of the second working optical signal L2′ and the second monitoring optical signal L2″ in the second wavelength optical signal L2 can be suitably adjusted according to an actual requirement.

Moreover, the light splitting and detecting system 1000 further includes a first light guide unit 150 and a second light guide unit 160. The first wavelength optical signal L1 and the second wavelength optical signal L2 can be respectively transmitted in the first light guide unit 150 and the second light guide unit 160. In detail, the filter 110 can be disposed between the first light guide unit 150 and the first wavelength filtering unit 130, and can be disposed between the second light guide unit 160 and the first wavelength filtering unit 130. The first wavelength optical signal L1 can be transmitted to the filter 110 through the first light guide unit 150. The second wavelength optical signal L2 can be transmitted to the filter 110 through the second light guide unit 160. In the present embodiment, the first light guide unit 150 and the second light guide unit 160 are, for example, optical fibers or other suitable light carrying elements. In the present embodiment, the first working optical signal L1′ and the second working optical signal L2′ reflected by the filter 110 may return back to the second light guide unit 160 and the first light guide unit 150 to depart from the light splitting and detecting apparatus 100.

Referring to FIG. 1, the first wavelength filtering unit 130 is disposed between the filter 110 and the light detecting unit 120. The first wavelength filtering unit 130 is pervious to the first monitoring optical signal L1″ and reflects at least a part of the second monitoring optical signal L2″. Namely, the first wavelength filtering unit 130 is adapted to filter at least a part of the second wavelength optical signal L2.

The light detecting unit 120 is disposed on a transmission path of the first monitoring optical signal L1″ passing through the filter 110. The slit 140 is disposed between the first wavelength filtering unit 130 and the light detecting unit 120, and exposes the light detecting unit 120. In detail, in the present embodiment, the slit 140 is, for example, a conical slit. The conical slit has a first opening S1 and a second opening S2 opposite to each other. The first opening S1 is located between the second opening S2 and the first wavelength filtering unit 130, and the second opening S2 covers at least a part of the light detecting unit 120. Moreover, a diameter of the second opening S2 is greater than a diameter of the first opening S1. However, the invention is not limited thereto, and the slit 140 can be designed in other shapes.

In the light splitting and detecting apparatus 100, all of the optical signals (for example, the first and the second wavelength optical signals L1 and L2) are transmitted to the filter 110 first. Then, a part of the optical signals (the first and the second monitoring optical signals L1″ and L2″) pass through the filter 110. Then, at least a part of the second wavelength optical signal L2 (for example, the second monitoring optical signal L2″) in a part of the optical signals (for example, the first and the second monitoring optical signals L1″ and L2″) passing through the filtering unit 110 is filtered by the wavelength filtering unit 130.

In the present embodiment, a tangential direction T1 of the first light guide unit 150 near the filter 110 is intersected with a tangential direction T2 of the second light guide unit 160 near the filter 110. In other words, an angle of the first wavelength optical signal L1 incident to the filter 110 can be different to an angle of the second wavelength optical signal L2 incident to the filter 110. Therefore, a part of the first wavelength optical signal L1 (for example, the first monitoring optical signal L1″) passing through the first wavelength filtering unit 130 can enter the slit 140 along a path P1, and is then transmitted to the light detecting unit 120. A part of the second wavelength optical signal L2 (for example, the second monitoring optical signal L2″) passing through the first wavelength filtering unit 130 can be transmitted along a path P2, and is reflected by an outer wall of the slit 140. In other words, by configuring the slit 140 in the light splitting and detecting apparatus 100, a part of the first wavelength optical signal L1 (for example, the first monitoring optical signal L1″) is easy to be transmitted to the light detecting unit 120, and a part of the second wavelength optical signal L2 (for example, the second monitoring optical signal L2″) is blocked from being transmitted to the light detecting unit 120. In this way, the light detecting unit 120 can accurately detect the light intensity of the first monitoring optical signal L1″, and a detection result of the light detecting unit 120 is unlikely to be interfered by the second monitoring optical signal L2″.

According to another aspect, a function of the first wavelength filtering unit 130 and the slit 140 is to ensure a single optical signal (for example, the first wavelength optical signal L1) to be transmitted to the light detecting unit 120. As shown in FIG. 1, if a power of the second wavelength optical signal L2 is too strong and limits the function of the first wavelength filtering unit 130, a second wavelength filtering unit 135 can be added. The second wavelength filtering unit 135 can be disposed between the first wavelength filtering unit 130 and the slit 140. The second wavelength filtering unit 135 is substantially the same to the first wavelength filtering unit 130. The second wavelength filtering unit 135 is also pervious to the first monitoring optical signal L1″ and reflects at least a part of the second monitoring optical signal L2″. By using the second wavelength filtering unit 135, the intensity of the second wavelength optical signal L2 transmitted to the light detecting unit 120 is further decreased, such that the intensity of the first monitoring optical signal L1″ to be detected by the light detecting unit 120 is more unlikely to be interfered by the second wavelength optical signal L2.

In the present embodiment, the light splitting and detecting apparatus 100 further includes a metal inner tube 170, a glass substrate 180 and a metal outer tube 190. The glass substrate 180, the filter 110, the first wavelength filtering unit 130 and the second wavelength filtering unit 135 can be sleeved by the metal inner tube 170, and the filter 110 can be disposed between the glass substrate 180 and the first wavelength filtering unit 130. In other words, the filter 110, the first wavelength filtering unit 130 and the second wavelength filtering unit 135 are sequentially disposed on the glass substrate 180, such that the optical signals (the first and the second wavelength optical signals L1 and L2) are sequentially transmitted to the glass substrate 180, the filter 110, the first wavelength filtering unit 130 and the second wavelength filtering unit 135.

The metal outer tube 190 has a first end 190a and a second end 190b opposite to each other. The metal inner tube 170 is disposed at the first end 190a of the metal outer tube 190, and the slit 140 and the light detecting unit 120 are disposed at the second end 190b of the metal outer tube 190.

In the present embodiment, although the first wavelength filtering unit 130 and the second wavelength filtering unit 135 can filter a part of the second monitoring optical signal L2″, a part of high-power optical signal (for example, the second monitoring optical signal L2″ with the second wavelength) still enters the metal outer tube 190, and is propagated along the path P2 to form a diffused light. Through the slit 140 of the present embodiment, the diffused light is likely to be repeatedly reflected between the outer wall of the slit 140 and an inner wall of the metal outer tube 190 for attenuation, such that the result obtained as the light detecting unit 120 detects the first monitoring optical signal L1″ is unlikely to be interfered by the second monitoring optical signal L2″. In this way, the light splitting and detecting apparatus 100 of the present embodiment can detect a correct intensity of the optical signal (for example, the first monitoring optical signal L1″ with the first wavelength). In the present embodiment, the wavelength of the first monitoring optical signal L1″ can be 1310 nm. However, the invention is not limited thereto, and in other embodiments, the optical signal to be detected by the light detecting unit 120 can be changed along with an actual requirement, which can be achieved by adjusting the filter 110, the first wavelength filtering unit 130 and the second wavelength filtering unit 135.

Referring to FIG. 1, in the present embodiment, a length D of the light splitting and detecting apparatus 100 is, for example, 18 mm to 20 mm. A width W1 of the metal outer tube 190 is, for example, 5 mm to 7 mm. A height H of the slit 140 is, for example, 1 mm to 1.5 mm. A diameter d2 of the second opening S2 of the slit 140 is, for example, 1 mm to 1.2 mm, and a diameter d1 of the first opening S1 of the slit 140 is, for example, 0.1 mm to 0.25 mm. A width W2 of the light detecting unit 120 is, for example, 4.8 mm to 5.2 mm.

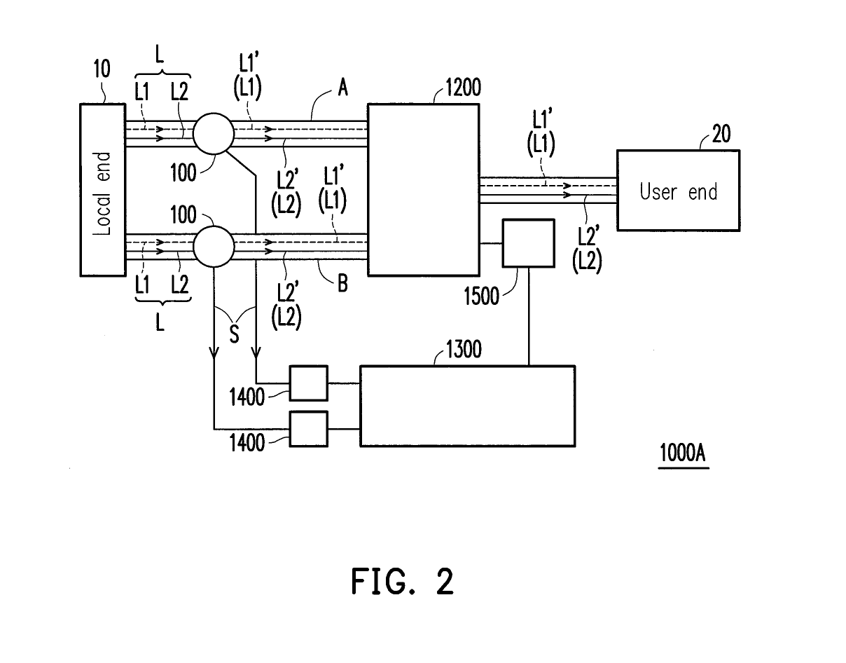

FIG. 2 is a schematic diagram of a light splitting and detecting system according to another embodiment of the invention. Referring to FIG. 2, the light splitting and detecting system 1000A includes at least two light splitting and detecting apparatuses 100 and an optical path switching device 1200. For example, the light splitting and detecting system 1000A can be applied to an optical signal network between two places. As shown in FIG. 2, a left end of FIG. 2 is, for example, a local end 10, and a right end of FIG. 2 is, for example, a user end 20. Namely, the optical signals sent by the local end 10 can be transmitted to the user end 20 through the light splitting and detecting system 1000A. The light splitting and detecting system 1000A is used to ensure that the optical signals are normally transmitted between the local end 10 and the user end 20. In the light splitting and detecting system 1000A, at least two same optical signals are respectively transmitted on at least two paths, and one of the paths serves as a main optical signal transmission path, and another path serves as an alternate optical signal transmission path. The optical signal transmission paths can be provided by optical fibers.

In the present embodiment, the light splitting and detecting apparatus 100 is the light splitting and detecting apparatus 100 of FIG. 1, and in FIG. 2, two light splitting and detecting apparatuses 100 are taken as an example for descriptions. In detail, the local end 10 can sent two sets of the same multi-wavelength optical signal L, and each set of the multi-wavelength optical signal L includes the first wavelength optical signal L1 and the second wavelength optical signal L2. The two sets of the same multi-wavelength optical signal L can be respectively transmitted in an optical fiber A and an optical fiber B. The optical fiber A and the optical fiber B are connected to the local end 10 and the optical path switching device 1200. The two optical fibers A and B can be respectively configured with the light splitting and detecting apparatus 100. The light splitting and detecting apparatus 100 can monitor a transmission status of the first wavelength optical signal L1 and the second wavelength optical signal L2 in the optical fiber A and the optical fiber B. The optical path switching device 1200 makes the multi-wavelength optical signal L (including the first wavelength optical signal L1 and the second wavelength optical signal L2) transmitted in one of the optical fiber A and the optical fiber B to pass through the optical path switching device 1200 according to a monitoring result of the light splitting and detecting apparatus 100.

Operation details of the light splitting and detecting system of the present embodiment are described below. In the present embodiment, a wavelength of the first wavelength optical signal L1 is, for example, 1310 nm, a wavelength of the second wavelength optical signal L2 is, for example, 1490 nm or 1550 nm. However, the invention is not limited thereto, and in other embodiments, the type and the wavelength of the optical signal can be adjusted according to an actual requirement.

In the present embodiment, the light splitting and detecting apparatus 100 extracts 5% of the light intensity of the first wavelength optical signal L1 and the second wavelength optical signal L2 from the optical fiber A and the optical fiber B for detection, so as to detect a magnitude of the light intensity of the first wavelength of the optical signal L1, and the other 95% of the light intensity is used for signal transmission. However, the invention is not limited thereto, a ratio between the optical signal used for detection and the optical signal used for signal transmission can be adjusted according to a design requirement.

Further, referring to the detailed descriptions of FIG. 1, the light splitting and detecting apparatus 100 extracts 5% of the first wavelength optical signal L1 and the second wavelength optical signal L2 (for example, the first monitoring optical signal L1″ and the second monitoring optical signal L2″ in FIG. 1) by using the filter 110, the first wavelength filtering unit 130 and the second wavelength filtering unit 135, and makes 95% of the first wavelength optical signal L1 and the second wavelength optical signal L2 (for example, the first working optical signal L1′ and the second working optical signal L2′ in FIG. 1) to depart from the light splitting and detecting apparatus 100. Moreover, a part of the second wavelength optical signal L2 can be filtered. Then, the light detecting unit 120 in the light splitting and detecting apparatus 100 converts a part of the first wavelength optical signal L1 (for example, the first monitoring optical signal L1″) into a first monitoring electric signal S to output. Moreover, the optical path switching device 1200 is disposed on a transmission path of the first working optical signal L1 and the second working optical signal L2′ divided by each of the light splitting and detecting apparatus 100.

In detail, the light splitting and detecting system 1000A further includes a micro control unit 1300, a plurality of amplifying elements 1400 and a control circuit 1500. The amplifying elements 1400 are respectively disposed between the light splitting and detecting apparatus 100 and the micro control unit 1300, and amplify the first monitoring electric signals S and output the amplified first monitoring electric signals S to the micro control unit 1300. The micro control unit 1300 is coupled to the light detecting unit 120 (shown in FIG. 1) of each of the light splitting and detecting apparatuses 100. The micro control unit 1300 analyses the first monitoring electric signal S to deduce whether a whole light intensity of the first wavelength optical signal L1 is normal. The control circuit 1500 is coupled between the micro control unit 1300 and the optical path switching apparatus 1200, and is controlled by the micro control unit 1300. The control circuit 1500 is used to drive the optical path switching device 1200, and the optical path switching device 1200 makes the first working optical signal L1′ and the second working optical signal L2′ divided by one of the light splitting and detecting apparatuses 100 to pass through the optical path switching device 1200.

For example, when the micro control unit 1300 calculates that the light intensity of the first wavelength optical signal L1 in the optical fiber A is too weak, the micro control unit 1300 drives the optical path switching device 1200 through the control circuit 1500, so as to make the first working optical signal L1′ and the second working optical signal L2′ divided by the light splitting and detecting apparatus 100 on the optical fiber B to pass through the optical path switching device 1200 for transmitting to the user end 20, which ensures the optical signal transmission between the local end 10 and the user end 20.

Since the main structure of the light splitting and detecting apparatus 100 is the filter and the light detecting unit. Compared to the light splitting and detecting apparatus 100 using a coupler, the light splitting and detecting apparatus 100 of the present embodiment avoids using a large amount of optical fiber lines, so that the light splitting and detecting system 1000A has a smaller size, for example, a size of 33 mm×46 mm×12 mm. Moreover, in the present embodiment, the micro control unit 1300 can use a linear equation to calculate light intensity of the optical signals, which saves a large amount of computation of database, and effectively shortens a switching speed of the light splitting and detecting system 1000A, for example, from 50 ms to 15 ms.

In summary, the light splitting and detecting system of the invention uses the filter and the first wavelength filtering unit to filter an extra optical signal, and further uses the slit to block the interference on the light detecting unit caused by the extra optical signal, so as to improve reliability of the detection result of the light splitting and detecting system.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light splitting and detecting system, comprising:
at least one light splitting and detecting apparatus, capable of receiving a first wavelength optical signal and a second wavelength optical signal, and comprising:
a filter, disposed on a transmission path of the first wavelength optical signal and the second wavelength optical signal, wherein the first wavelength optical signal is divided into a first working optical signal and a first monitoring optical signal, and the second wavelength optical signal is divided into a second working optical signal and a second monitoring optical signal, the filter reflects the first working optical signal and the second working optical signal, and is pervious to the first monitoring optical signal and the second monitoring optical signal;
a light detecting unit, disposed on a transmission path of the first monitoring optical signal passing through the filter;
a first wavelength filtering unit, disposed between the filter and the light detecting unit, wherein the first wavelength filtering unit is pervious to the first monitoring optical signal and reflects at least a part of the second monitoring optical signal; and
a slit, disposed between the first wavelength filtering unit and the light detecting unit, and exposing the light detecting unit.

2. The light splitting and detecting system as claimed in claim 1, wherein the at least one light splitting and detecting apparatus comprises at least two light splitting and detecting apparatuses.

3. The light splitting and detecting system as claimed in claim 2, further comprising an optical path switching device disposed on a transmission path of the first working optical signal and the second working optical signal divided by each of the light splitting and detecting apparatuses, wherein the optical path switching device is adapted to make the first working optical signal and the second working optical signal divided by one of the light splitting and detecting apparatuses to pass through the optical path switching device according to a value of a first monitoring electric signal sent by the optical detecting unit of each of the light splitting and detecting apparatuses.

4. The light splitting and detecting system as claimed in claim 3, further comprising: a micro control unit being coupled to the light detecting unit of each of the light splitting and detecting apparatuses and analysing the first monitoring electric signal.

5. The light splitting and detecting system as claimed in claim 4, further comprising: a plurality of amplifying elements, respectively being disposed between the light splitting and detecting apparatus and the micro control unit, wherein the amplifying elements configure to amplify the first monitoring electric signals and output the amplified first monitoring electric signals to the micro control unit.

6. The light splitting and detecting system as claimed in claim 5, further comprising: a control circuit, being coupled between the micro control unit and the optical path switching apparatus and being controlled by the micro control unit, wherein the control circuit is used to drive the optical path switching device, and the optical path switching device makes the first working optical signal and the second working optical signal divided by one of the light splitting and detecting apparatuses to pass through the optical path switching device.

7. The light splitting and detecting system as claimed in claim 1, further comprising a first light guide unit, wherein the filter is disposed between the first light guide unit and the first wavelength filtering unit, the first wavelength optical signal is transmitted to the filter through the first light guide unit.

8. The light splitting and detecting system as claimed in claim 7, further comprising: a second light guide unit, wherein the filter is disposed between the second light guide unit and the first wavelength filtering unit, the second wavelength optical signal is transmitted to the filter through the second light guide unit.

9. The light splitting and detecting system as claimed in claim 8, wherein a tangential direction of the first light guide unit near the filter is intersected with a tangential direction of the second light guide unit near the filter.

10. The light splitting and detecting system as claimed in claim 1, wherein the slit is a conical slit.

11. The light splitting and detecting system as claimed in claim 10, wherein the conical slit has a first opening and a second opening opposite to each other.

12. The light splitting and detecting system as claimed in claim 11, wherein the first opening is located between the second opening and the first wavelength filtering unit.

13. The light splitting and detecting system as claimed in claim 12, wherein the second opening covers at least a part of the light detecting unit.

14. The light splitting and detecting system as claimed in claim 13, wherein a diameter of the first opening is smaller than a diameter of the second opening.

15. The light splitting and detecting system as claimed in claim 14, wherein a diameter of the second opening of the slit is called d2, 1 mm≦d2≦1.2 mm, a diameter of the first opening of the slit is called d1, and 0.1 mm≦d1≦0.25.

16. The light splitting and detecting system as claimed in claim 1, further comprising a second wavelength filtering unit disposed between the first wavelength filtering unit and the slit, and is pervious to the first monitoring optical signal and reflects at least a part of the second monitoring optical signal.

17. The light splitting and detecting system as claimed in claim 1, wherein a wavelength of the first wavelength optical signal is 1310 nanometer (nm).

18. The light splitting and detecting system as claimed in claim 1, wherein a wavelength of the second wavelength optical signal is 1490 nm or 1550 nm.

19. The light splitting and detecting system as claimed in claim 1, wherein a light intensity of the first working optical signal is 95% of a light intensity of the first wavelength optical signal, and a light intensity of the first monitoring optical signal is 5% of the light intensity of the first wavelength optical signal.

20. The light splitting and detecting system as claimed in claim 1, wherein a light intensity of the second working optical signal is 95% of a light intensity of the second wavelength optical signal, and a light intensity of the second monitoring optical signal is 5% of the light intensity of the second wavelength optical signal.
